(19) United States
(12) Patent Application Publication
(10) Pub. No.: US 2010/0161244 A1
(43) Pub. Date: Jun. 24, 2010

(54) METHOD AND APPARATUS FOR MONITORING STRUCTURAL HEALTH

(75) Inventors: Anindya Ghoshal, Middletown, CT (US); Roxana Zangor, Candiac (CA); Zaffir A. Chaudhry, South Glastonbury, CT (US); Jimmy Lih-Min Yeh, West Hartford, CT (US); Jeffery R. Schaff, North Haven, CT (US); Mark W. Davis, Southbury, CT (US)

Correspondence Address: Carlson, Gaskey, & Olds, P.C./Sikorsky, 400 West Maple Road, Suite 350, Birmingham, MI, 48009, US

(73) Assignee: SIKORSKY AIRCRAFT CORPORATION, Stratford, CT (US)

(21) Appl. No.: 12/337,848

(22) Filed: Dec. 18, 2008

(51) Int. Cl. G01L 1/00; G06F 19/00

(52) U.S. Cl. 702/35

(57) ABSTRACT

A method includes performing a first damage prediction with a computational model using at least data from a first multitude of damage sensors on a structure, performing a second damage prediction with the computational model using at least data from a second multitude of load sensors associated with the structure, and selectively performing a damage monitoring action in response to the first damage prediction and the second damage prediction to determine a structural health A system includes a computing device configured to perform a first damage prediction using at least data from a multitude of damage sensors on a structure, a second damage predication using at least data from a multitude of load sensors associated with the structure, so as to selectively perform a damage monitoring action in response to the first damage prediction and the second damage prediction to determine a structural health of the structure.

### BACKGROUND

This application relates to structural health management, and more particularly to a method for monitoring a health of a structure.

Rotary-wing aircraft and other structures may be routinely subjected to operational conditions which may result in stress and vibration. Since the components of the structure may have a measurable and predictable life cycle, prediction of component deterioration so as to anticipate a potential failure facilitates prolonged operations. Early detection of potential failures or fractures within a structural component provides the ability to perform preventative maintenance and avoid potential component failure.

Manual inspection is one method of monitoring structural health. More recently, some aircraft have incorporated Health and Usage Monitoring Systems (“HUMS”) to monitor the health of critical components and collect operational flight data utilizing on-board accelerometers, sensors, and avionic systems.

### SUMMARY

A method according to one non-limiting embodiment includes performing a first damage prediction with a computational model using at least data from a first multitude of damage sensors on a structure, performing a second damage prediction with the computational model using at least data from a second multitude of load sensors associated with the structure, and selectively performing a damage monitoring action in response to the first damage prediction and the second damage prediction to determine a structural health.

A system according to one non-limiting embodiment includes at least one computing device configured to perform a first damage prediction using at least data from a multitude of damage sensors on a structure, a second damage predication using at least data from a multitude of load sensors associated with the structure, so as to selectively perform a damage monitoring action in response to the first damage prediction and the second damage prediction to determine a structural health of the structure.

These and other features of the present application can be best understood from the following specification and drawings, the following of which is a brief description.

### BRIEF DESCRIPTION OF THE DRAWINGS

FIG. 1 schematically illustrates in block diagram form one structural health monitoring flowchart.

FIG. 2a illustrates a first view of an example structure.

FIG. 2b illustrates a second view of the structure of FIG. 2a.

FIG. 3 schematically illustrates a multitude of sensors applied to the structure of FIGS. 2a, 2b.

FIG. 4 schematically illustrates a system for structural health monitoring.

FIG. 5 schematically illustrates a plurality of damage monitoring actions.

FIG. 6 schematically illustrates in block diagram another structural health monitoring flowchart.

FIG. 7 schematically illustrates a crack size estimate decision flowchart.

### DETAILED DESCRIPTION OF THE EXEMPLARY EMBODIMENTS

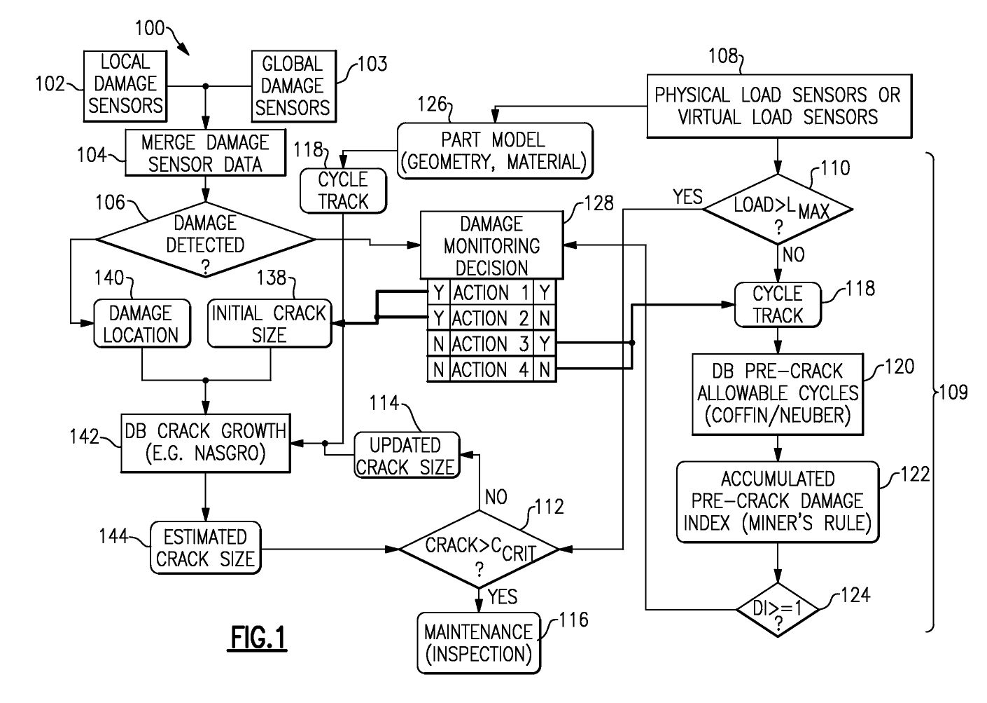

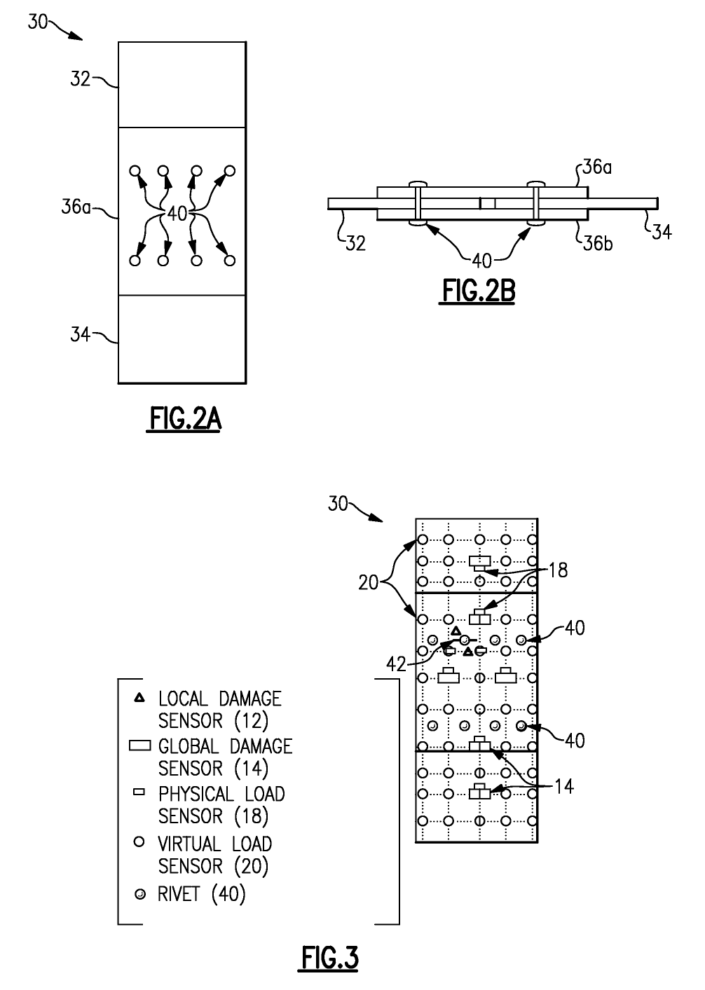

FIG. 1 schematically illustrates one non-limiting embodiment of a method 100 of monitoring a health of a structure 30 (see FIGS. 2a, 2b). The method 100 may be utilized to analyze the health of various structures, such as, for example only, an airframe. The structure 30 may include a first component 32, a second component 34, a first connecting component 36a, a second connecting component 36b, and a plurality of fasteners 40 to secure the components 32, 34, 36a, 36b together. In one example the fasteners are rivets. It is understood that FIGS. 2a and 2b, and 3 are exemplary, and that other structures could be analyzed and that other fasteners could be used.

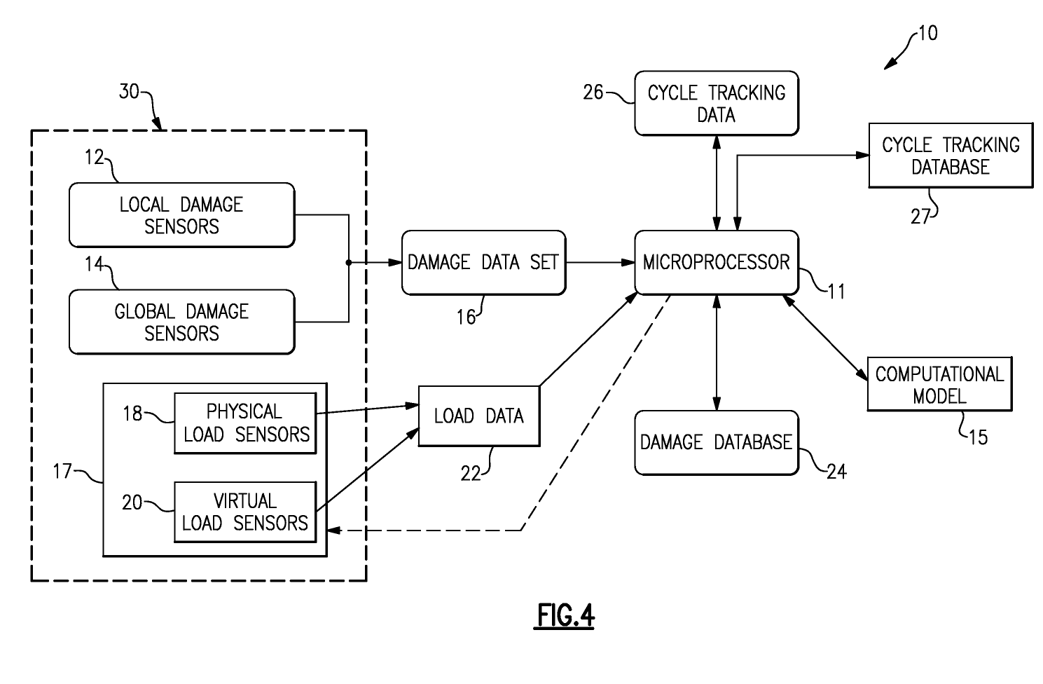

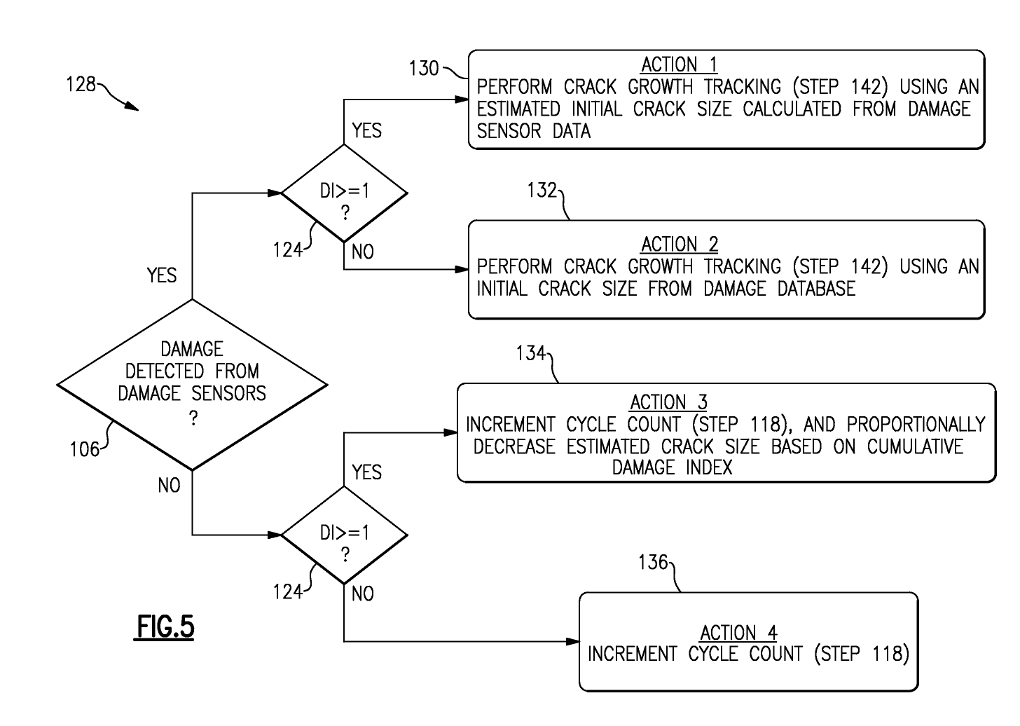

A multitude of local damage sensors 12 and a multitude of global damage sensors 14 are applied to the structure 30 (see FIGS. 3, 4). A damage sensor is any device that can either sense a deviation in a structure from its original configuration or that can produce a signal that can be used to sense the deviation in the structure from its original configuration. In one example, the local damage sensors 12 are applied to areas on the structure where damage is likely to occur, or “hot spots,” where a crack 42 has occurred either during testing or during actual operational conditions (e.g. from a helicopter fleet history). In one example the local damage sensors are either ultrasonic sensors, phase data sensors, or crack gauges. As shown in FIG. 3, the second quantity of global damage sensors 14, such as piezo sensors, is greater than the first quantity of local damage sensors 12. The global damage sensors 14 may be applied uniformly to a large area of the structure 30 to form a sensor network. The virtual load sensors 20, possibly in combination with the physical load sensors 18, may also be configured to form a sensor network.

Data is received from the multitude of local damage sensors 12 (action 102) and data is received from the multitude of global damage sensors 14 (action 103). The local sensor data and global sensor data is then merged (action 104) to form a damage data set 16 (FIG. 4). A first damage prediction (action 106) is performed in response to the damage data set 16. The first damage prediction 106 may include using software to process the damage data set 16 to determine if any damage such as a crack has formed in the structure 30. In one example, software may be used to compare the damage data set 16 to predicted sensor data for a cracked or damaged structure. It is understood that the term “damage prediction” includes both detecting damage from actual operational condition data (e.g. from a helicopter fleet history), and also predicting damage from test data.

An initial crack size estimate (action 138) and a damage location estimate (action 140) are performed in response to the first damage prediction (action 106). The initial crack size estimate (action 138) may be calculated using data from the damage data set 16 or from a damage database 24, which contains data regarding crack sizes and other criteria (see FIG. 4). The damage database 24 may contain data, such as global stress amplitude, global stress history, crack length, axial stress amplitude distribution, transverse stress amplitude distribution, as well as alternative or additional data, to classify a crack. In one example, the damage database 24 is populated with data based upon measured, experimental data in the particular component 30.

Load data 22 is also received from a multitude of load sensors (action 108). A load sensor is any device for sensing loads in a structure. In one non-limiting embodiment, the load sensors 17 are physical load sensors 18, such as accelerometers or bi-directional strain gauges, applied to the structure 30 (see FIGS. 3, 4). In another non-limiting embodiment, the load sensors 17 are virtual sensors 20 that correspond to a computational model 15 for estimating an applied load based on state parameters, such as aircraft altitude, aircraft velocity, etc. (see FIGS. 3, 4). While it is possible to use physical load sensors 18 and virtual load sensors 20 simultaneously, it should be understood that both types of load sensors need not be required.

A second damage prediction (action 109) is performed in response to the load data 22 from the load sensors 17 (see FIG. 4). A check is performed to determine if a sensed load exceeds a maximum allowable load (“Lₘₐₓ”) for the structure (action 110). If the sensed load exceeds the maximum allowable load, it is determined that the structure 30 has been damaged, and an estimated crack size 144 is compared to a critical crack size for the structure (action 112). If the estimated crack size does not exceed the critical crack size (“C_{crit}”), it may be determined that the structure 30 is still usable, but the estimated crack size 144 is updated (action 114). If the estimated crack size does exceed the critical crack size, it is determined that the structure 30 should be inspected, and a maintenance request, such as an inspection flag, is triggered (action 116).

If the sensed load does not exceed the maximum allowable load for the structure (action 110), a cycle count for a stress level is incremented in response to the structure experiencing oscillations at the stress level (action 118). It is understood that in this application the term “oscillations” can include vibratory loads and can include dynamic loads. Incrementing the cycle count includes obtaining cycle tracking data 26 from memory, and then updating the cycle tracking data 26 (see FIG. 4). Storing cycle tracking data 26 in memory allows cycle tracking data to be retained from previous occasions so that cycle tracking (action 118) is cumulative. In one example cycle tracking data is maintained and tracked in a ground station. A ratio of an experienced number of cycles to a predetermined maximum allowable number of cycles for a stress level is then calculated (action 120). In one non-limiting embodiment the maximum allowable number of cycles is determined using Neuber's rule (equation #1 below) and the Basquin-Coffin rule (equation #2 below). In one non-limiting embodiment, equations #1 and 2 may be used to populate a cycle tracking database 27 so that a maximum number of allowable cycles for a stress level may be retrieved from memory.

$$\frac{{K}_{f}^{2} {Δσ}_{nom}}{2} [ \frac{{Δσ}_{nom}}{2 E} + {( \frac{{Δσ}_{nom}}{2 K} )}^{1 / n} ] = \frac{{Δσ}^{2}}{4 E} + \frac{Δσ}{2} {( \frac{Δσ}{2 K} )}^{1 / n} \qquad [ equation \#1 ]$$

where K_{f} is a fatigue notch factor;
Δσₙₒₘ is a nominal stress range;
E is a modulus of elasticity;
Δσ is a local stress range; and
K and n are parameters of a non-linear stress-strain relation.

$$\frac{Δɛ}{3} = \frac{{σ}_{f}}{E} {( 2 {N}_{f} )}^{b} + {{ɛ}_{f} ( 2 {N}_{f} )}^{c} \qquad [ equation \#2 ]$$

where Δε is a total strain amplitude in a notch root;
σ_{f} is a fatigue stress coefficient;
ε_{f} is a fatigue ductility coefficient;
N_{f} is a number of remaining cycles until a crack initiation occurs; and
b and c are fatigue stress exponents.

Equations #3 and #4 shown below illustrate how equations #1 and #2 are related, and may be used along with equations #1 and #2

$$\begin{matrix}K = \frac{{σ}_{f}}{{( {ɛ}_{f} )}^{n}} & [ equation \#3 ] \\ n = \frac{b}{c} & [ equation \#4 ]\end{matrix}$$

A sum of the ratios for each of the stress levels is then calculated (action 122; for example by Miner's rule) to obtain a cumulative damage index “DI”. A check is then performed to determine if the cumulative damage index meets or exceeds a threshold (action 124). While action 124 illustrates an example threshold of 1, it is understood that other thresholds could be used. The second damage prediction 109 includes actions 110, 118, 120, 122, and 124 (FIG. 1). If the load sensors 17 correspond to virtual load sensors 20, it may be necessary to retrieve information about the structure, such as geometry and material information of the structure (action 126).

Referring to FIG. 4, a system 10 for structural health monitoring is schematically illustrated. The system 10 generally includes a microprocessor 11, a computational model 15, a damage data set 16, a load data 22, a damage database 24, cycle tracking data 26, and cycle tracking database 27. In one example the computational model 15 includes a damage model corresponding to the damage sensors 12, 14 and a load model corresponding to the load sensors 17. The computational model 15 and the microprocessor 11 may be part of a HUMS application or another on-board application where sensor data is processed in real-time. Also, the computational model 15 and the microprocessor 11 may also be part of an offline application where sensor data is downloaded and processed after being recorded. The microprocessor 11 may be part of a computer. In one example the computational model 15, damage data set 16, load data 22, damage database 24, cycle tracking data 26, and cycle tracking database 27 are stored in memory that is in communication with the microprocessor 11. The memory may, for example only, include UVPROM, EEPROM, FLASH, RAM, ROM, DVD, CD, a hard drive, or other computer readable medium which stores the data. The microprocessor 11 is operable to receive data from a computational model 15, to update the computational model 15 in response to the damage data set 16 and the load data 22, and to interact with the computational model 15 to provide the virtual load sensors 20. The microprocessor 11 is operable to receive and process the damage data set 16 and the load data 22, and is operable to perform the actions illustrated in the method 100 (FIG. 1).

It should be noted that a computing device can be used to implement various functionality of the computational model, such as that attributable to the system 10. In terms of hardware architecture, such a computing device may include the microprocessor 11, memory (as described above), and one or more input and/or output (I/O) device interface(s) that are communicatively coupled via a local interface. The local interface may include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The microprocessor 11 may be a hardware device for executing software, particularly software stored in memory. The microprocessor may be a custom made or commercially available processor, a central processing unit (CPU), an auxiliary processor among several processors associated with the computing device, a semiconductor based microprocessor (in the form of a microchip or chip set) or generally any device for executing software instructions.

The memory may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory may also have a distributed architecture, where various components are situated remotely from one another, but may be accessed by the processor.

The software in the memory (e.g. the computational model 15) may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the microprocessor 11 may be configured to execute software stored within the memory, to communicate data to and from the memory, and to generally control operations of the computing device pursuant to the software. Software in memory, in whole or in part, is read by the processor, perhaps buffered within the processor, and then executed.

In one example, the damage sensors 12 and 14 corresponds to a first tier of a structural health monitoring architecture, the load sensors 17 correspond to a second tier of the structural health monitoring architecture, and the computational model 15 corresponds to a third tier of the structural health monitoring architecture.

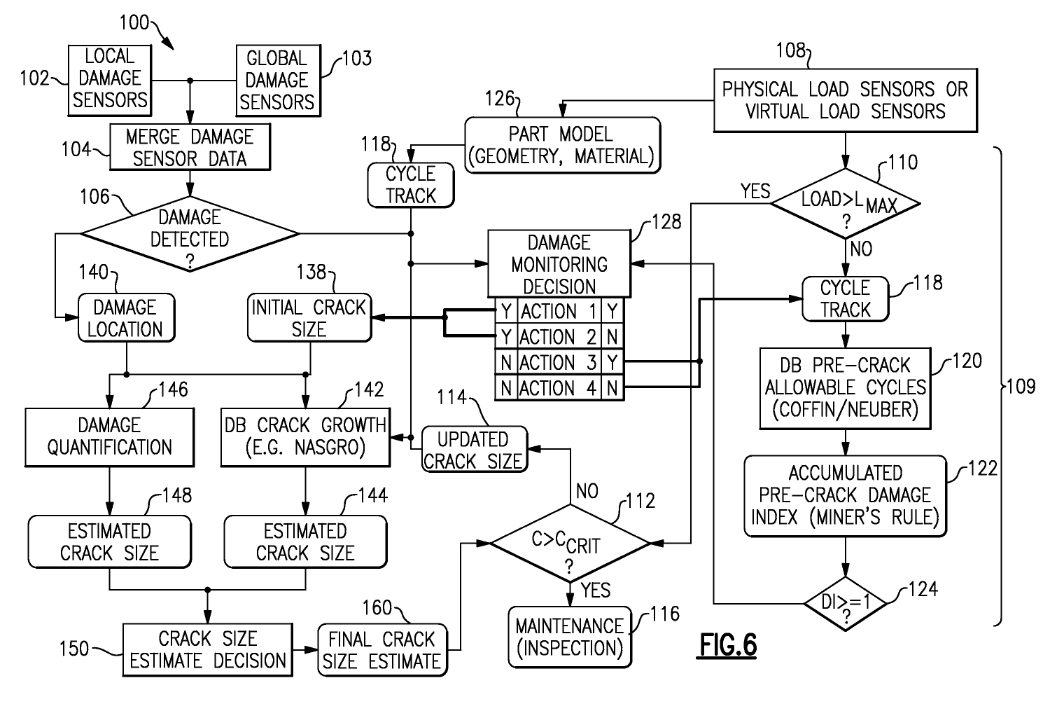

Referring to FIG. 5, a damage monitoring decision is performed (action 128) in response to the first damage prediction (action 106) and the second damage prediction (action 109). One of four damage monitoring actions (130, 132, 134, 136) may performed in response to the damage monitoring action decision 128 (see FIGS. 1, 5). However, it is understood that the damage monitoring actions (130, 132, 134, 136) are exemplary, and that alternative or additional damage monitoring actions would be possible.

If the first damage prediction (action 106) detects damage and the second damage prediction (action 109) detects damage, the first damage monitoring action (action 130) is performed. The first damage monitoring action includes performing crack growth tracking (action 142) using an initial crack size estimate (action 138) calculated from the damage data set 16. In one example the crack growth tracking (action 142) may be performed using the NASGRO equation. In another example, the crack growth tracking may be performed using finite element analysis software.

If the first damage prediction (action 106) detects damage and the second damage prediction (action 109) does not detect damage, a second damage monitoring action (action 132) is performed. The second damage monitoring action includes performing crack growth tracking (action 142) using an initial crack size estimate (action 136) from a damage database 24 (see FIG. 4).

If the first damage prediction (action 106) does not detect damage and the second damage prediction (action 109) detects damage, then a third damage monitoring action (action 134) is performed. The third damage monitoring action includes incrementing a cycle count (action 118) for a stress level in response to the structure experiencing oscillations at the stress level, and proportionally decreasing an estimated crack size (action 144) based on the cumulative damage index.

If the first damage prediction (action 106) does not detect damage and the second damage prediction (action 109) does not detect damage, then it may be determined that the structure 30 has not experienced damage, and a fourth damage monitoring action (action 136) is performed. The fourth damage monitoring action includes incrementing a cycle count (action 118) for a stress level in response to the structure experiencing oscillations at the stress level.

As discussed above, an estimated crack growth size 144 is compared to a critical crack size for the structure (action 112), and if the estimated crack size does not exceed the critical crack size, then it may be determined that the structure is still healthy, and the estimated crack size is updated (action 114). If the estimated crack size does exceed the critical crack size, the system 10 determines that the structure requires maintenance, and a maintenance request, such as an inspection flag, is triggered (action 116).

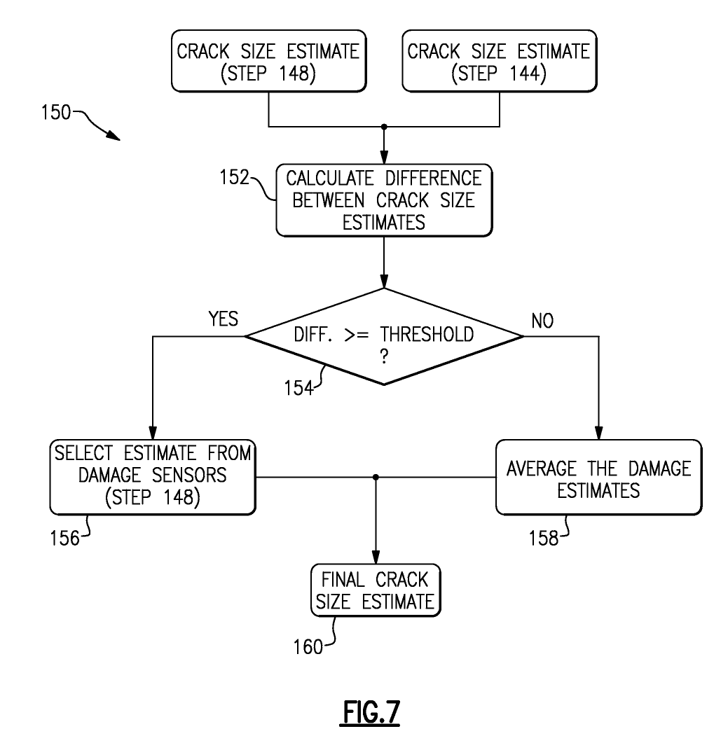

FIG. 6 schematically illustrates another non-limiting embodiment of a method 101 of monitoring a health of a structure. In this embodiment, a damage quantification estimate (action 146) and crack size estimate (action 148) are performed in response to the first damage prediction (action 106) detecting damage. A crack size estimate decision (action 150) is performed in response to the crack size estimates (actions 144, 148). FIG. 7 schematically illustrates an example crack size estimate decision 150. A difference between the crack size estimates is calculated (action 152), and the difference is compared to a threshold (action 154). If the difference meets or exceeds the threshold, then the crack size estimate from action 148 is selected as a final crack size estimate (action 160). If the difference is less than the threshold, then the crack size estimates from actions 144 and 148 are averaged to produce the final crack estimate (action 160).

Although preferred embodiments of this application have been disclosed, these embodiments are only exemplary, and a worker of ordinary skill in this art would recognize that certain modifications would come within the scope of this application. For that reason, one should study the following claims to determine the true scope and content of this invention.

What is claimed is:

1. A method comprising:
performing a first damage prediction with a computational model using at least data from a first multitude of damage sensors mounted to a structure;
performing a second damage prediction with the computational model using at least data from a second multitude of load sensors associated with the structure; and
selectively performing a damage monitoring action in response to the first damage prediction and the second damage prediction to determine a structural health.

2. The method of claim 1, further comprising:
predicting a structural health of the structure in response to the first damage prediction and the second damage prediction, the structural health including at least one of a comparison of a cumulative damage index to a predetermined threshold, a comparison of an estimated crack size to a critical crack size, and a comparison of an experienced number of cycles to a maximum allowable number of cycles

3. The method of claim 1, further comprising:
updating the computational model on a computer using at least the data from the first multitude of load sensors and using the data from the second multitude of damage sensors, wherein the computational model is stored in memory on a computer.

4. The method of claim 4, further comprising:
receiving data from the first multitude of damage sensors, the first multitude of damage sensors including a multitude of local damage sensors applied to the structure and a multitude of global damage sensors applied to the structure; and
merging data from the multitude of local damage sensors and the multitude of global damage sensors to form a damage data set stored in memory in communication with the computer.

5. The method of claim 1, further comprising:
identifying areas on the structure where damage is likely to occur under operational conditions;
mounting a first quantity of the multitude of local damage sensors to the areas where damage is likely to occur; and
mounting a second quantity of the multitude of global damages sensors to a plurality of locations on the structure, the second quantity greater than the first quantity.

6. The method of claim 1, further comprising:
receiving data from the second multitude of load sensors, the second multitude of load sensors including at least one of physical load sensors mounted to the structure or virtual load sensors associated with the structure.

7. The method of claim 1, wherein said performing a first damage prediction comprises:
processing the data from the first multitude of damage sensors; and
determining if a crack has formed on the structure using the processed data.

8. The method of claim 1, wherein said performing a second damage prediction comprises:
processing the data from the second multitude of load sensors; and
determining if a sensed load sensed by the second multitude of load sensors exceeds a maximum load for the structure.

9. The method of claim 1, wherein said performing a second damage prediction further comprises:
calculating a cumulative damage index in response to a sensed load not which does not exceed a maximum load; and
determining if the cumulative damage index is greater than or equal to a threshold value.

10. The method of claim 9, wherein said calculating a cumulative damage index comprises:
incrementing a cycle count for a stress level in response to identification that the structure experienced oscillations at the stress level;
calculating a ratio of an experienced number of cycles to a predetermined maximum allowable number of cycles for each stress level experienced by the structure; and
calculating a sum of the ratios for each of the stress levels to calculate a cumulative damage index.

11. The method of claim 1, wherein said selectively performing a damage monitoring action includes estimating an initial crack size calculated from data received from the damage sensors and tracking crack growth tracking in response to the initial crack size if the first damage prediction predicts damage and the second damage prediction predicts damage.

12. The method of claim 1, wherein said selectively performing a damage monitoring action includes tracking crack growth and referencing an initial crack size from a damage database if the first damage prediction predicts damage and the second damage prediction does not predict damage.

13. The method of claim 1, wherein said selectively performing a damage monitoring action further comprises:
incrementing a cycle count for a stress level in response to the structure experiencing oscillations at the stress level if the first damage prediction does not detect predict and the second damage prediction predicts damage; and
proportionally decreasing an estimated crack size based on a cumulative damage index if the first damage prediction does not detect predict and the second damage prediction predicts damage.

14. The method of claim 1, wherein said selectively performing a damage monitoring action further comprises:
incrementing a cycle count for a stress level in response to the structure experiencing oscillations at the stress level if the first damage prediction does not predict damage and the second damage prediction does not predict damage.

15. The method of claim 1, further comprising:
performing a first crack size estimate by referencing a damage database in response to the first damage prediction predicting damage.

16. The method of claim 15, further comprising:
performing a second crack size estimate based on data from the multitude of damage sensors in response to the first damage prediction predicting damage.

17. The method of claim 16, further comprising selecting the second crack size estimate as a final crack size estimate if a difference between the first crack size estimate and the second crack size estimate exceeds a threshold.

18. The method of claim 16, further comprising:
selecting an average of the first crack size estimate and the second crack size as a final crack estimate if a difference between the first crack size estimate and the second crack size estimate does not exceed a threshold.

19. A system for structural health monitoring, comprising:
a computing device configured to perform a first damage prediction using at least data from a multitude of damage sensors on a structure, a second damage prediction using at least data from a multitude of load sensors associated with the structure, so as to selectively perform a damage monitoring action in response to the first damage prediction and the second damage prediction to determine a structural health of the structure.

20. The system of claim 19, further comprising:
a damage database configured to contain damage information associated with the multitude of damage sensors, wherein the computing device accesses the damage information to perform the first damage prediction; and
a cycle tracking database configured to contain cycle tracking information associated with a quantity of cycles experienced by the structure at a plurality of stress levels, wherein the computing device accesses the cycle tracking information to perform the second damage prediction.
